(19) United States
(12) Patent Application Publication
(10) Pub. No.: US 2026/0155885 A1
(43) Pub. Date: Jun. 4, 2026

(54) Repeater Controlled by Terminal Device and Method for Controlling the Same

(71) Applicant: NATIONAL SUN YAT-SEN UNIVERSITY, Kaohsiung City (TW)

(72) Inventors: Chao-Kai Wen, Kaohsiung City (TW); Yen-Cheng Chan, Kaohsiung City (TW); Tzu-Hao Huang, Kaohsiung City (TW)

(21) Appl. No.: 19/315,886

(22) Filed: Sep. 2, 2025

(30) Foreign Application Priority Data
Dec. 3, 2024 (TW) 113146800

(51) Int. Cl. H04B 7/155; H04W 4/80

(52) U.S. Cl. CPC H04B 7/15528; H04W 4/80

(57) ABSTRACT

A repeater controlled by a terminal device includes a communication unit, a control unit, and a conversion unit. The communication unit is coupled to the terminal device through a short-range communication protocol. The communication unit transmits feedback data to the terminal device and receives a control instruction from the terminal device. The control unit is coupled to the communication unit for receiving the control instruction including a target frequency band and a communication specification. The conversion unit is electrically connected to a receiving antenna and a transmitting antenna. The receiving antenna receives a first signal from a base station. The conversion unit adjust a frequency of the first signal to generate a second signal in a target frequency band. The transmitting antenna transmits the second signal to the terminal device. A method for controlling the repeater is also provided.

### CROSS REFERENCE TO RELATED APPLICATION

The application claims the benefit of Taiwan application serial No. 113146800, filed on Dec. 3, 2024, and the entire contents of which are incorporated herein by reference.

### BACKGROUND OF THE INVENTION

### 1. Field of the Invention

The present invention relates to a wireless communication system and, more particularly, to a repeater controlled by a terminal device and a method for controlling the repeater.

### 2. Description of the Related Art

With the development of fifth generation (5G) mobile communication technology, multi-input multi-output (MIMO) technology has been widely applied to improve the data transmission efficiency and the spectrum efficiency of a system. Traditional MIMO technology has gradually evolved with increasing demands, and has developed into massive MIMO at the base station end, improving system capacity through configuring more antennas. Due to the larger size of base station equipment, there are relatively fewer design limitations on accommodating more antenna.

However, terminal devices face more limitations in antenna design due to the smaller overall size. Particularly, 5G terminal devices generally have larger antenna sizes, limiting the number of antennas that can be configured, which restricts the performance of terminal devices due to the number of receiving antennas and the limitations of communication frequency bands used by each antenna. Furthermore, existing repeaters are typically controlled by base stations as the control center, which not only increases the burden of communication between base stations and excessive terminal devices but also lacks the ability to dynamically regulate according to the needs of the terminal devices.

In view of this, it is necessary to improve the conventional repeaters and the control methods in conventional wireless communication systems.

### SUMMARY OF THE INVENTION

To solve the above problems, it is an object of the present invention to provide a repeater controlled by a terminal device, which can increase the number of antenna usage and spectrum efficiency for the terminal device.

It is another object of the present invention to provide a repeater controlled by a terminal device, which can simplify the design and reducing the size of the repeater, making it easier to be integrated into portable electronic products.

It is yet another object of the present invention to provide a control method for a repeater with an efficient phase regulation mechanism that can improve the quality and stability of signal.

It is a further object of the present invention to provide a control method for a repeater that can adjust phase in real-time and effectively to reduce phase regulation time.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

The repeater controlled by a terminal device of the present invention includes a communication unit, a control unit, and a conversion unit. The communication unit is coupled to the terminal device through a short-range communication protocol. The communication unit transmits feedback data to the terminal device, which includes a convertible frequency range and supportable signal specifications. The communication unit receives a control instruction from the terminal device, which includes a target frequency band and a communication specification. The control unit is coupled to the communication unit, configured to receive the control instruction. The conversion unit is electrically connected to a receiving antenna and a transmitting antenna respectively. The receiving antenna receives a first signal from a base station. The conversion unit is coupled to the control unit. The control unit operates the conversion unit to adjust a frequency of the first signal according to the control instruction to generate a second signal in the target frequency band. The transmitting antenna transmits the second signal to the terminal device.

Therefore, the repeater controlled by the terminal device of the present invention, through the terminal device instructing the repeater to perform signal frequency conversion, can convert signals to communication frequency bands of idle antennas, thereby increasing the number of antenna usage and spectrum efficiency of the terminal device, and achieving the effect of simplifying the design and reducing the size of the repeater.

In an example, the communication unit transmits a regulation indicator to the terminal device, receives a phase update instruction from the terminal device, and transmits the phase update instruction to the control unit. Thus, the phase can be dynamically adjusted based on real-time measured regulation indicator, achieving the effect of real-time and precise phase regulation.

In an example, the repeater of the present invention further includes a phase shift unit electrically connected to the conversion unit, the receiving antenna and the transmitting antenna. The phase shift unit is coupled to the control unit, and the control unit controls the phase shift unit according to the phase update instruction to regulate a phase of at least one of the first signal and the second signal. Thus, the signal phase can be dynamically adjusted, achieving the effect of improving communication stability and efficiency.

In an example, when the terminal device determines that a variation of the regulation indicator is greater than a preset threshold, the terminal device determines the phase update instruction to transmit to the communication unit. Thus, communication interruption due to signal attenuation or interference can be avoided, achieving the effect of enhancing system communication stability.

In an example, when the terminal device detects that a communication quality of the second signal is lower than a quality threshold, the terminal device determines the phase update instruction to transmit to the communication unit. Thus, the terminal device can control the repeater to perform phase updates based on real-time changes in the second signal quality, achieving the effect of adapting to environmental changes and improving signal stability.

A method for controlling a repeater of the present invention is executed by a terminal device to control the aforementioned repeater. The method includes: the terminal device establishing a connection with the repeater through a short-range communication protocol; the terminal device receiving feedback data from the repeater, which includes a convertible frequency range and supportable signal specifications of the repeater; the terminal device deciding a control instruction corresponding to a target frequency band and a communication specification, and transmitting the control instruction to the repeater; the repeater adjusting a frequency of a first signal from a base station according to the feedback data and the control instruction to generate a second signal in the target frequency band; and the repeater transmitting the second signal to the terminal device.

Therefore, the method for controlling the repeater of the present invention, through the feedback data and control instruction from the terminal device, controls the repeater to perform signal frequency conversion, can convert signals to communication frequency bands of idle antennas in the terminal device, thereby increasing the number of antenna usage and spectrum efficiency of the terminal device, and achieving the effect of simplifying the design and reducing the size of the repeater.

In an example, the repeater repackages the first signal according to the control instruction to comply with the communication specification. Thus, converting signals to formats compliant with different communication protocols enhances system compatibility and flexibility, achieving the effect of supporting multi-protocol operations.

In an example, the repeater regulates a phase of at least one of the first signal and the second signal according to a phase update instruction. Thus, the signal phase can be dynamically adjusted, achieving the effect of improving communication stability and efficiency.

In an example, the terminal device detects a regulation indicator of the repeater, and when a variation of the regulation indicator is greater than a preset threshold, the terminal device determines the phase update instruction. Thus, through the dynamic detection by adaptively selecting regulation indicators, the real-time status of communication links can be accurately reflected, achieving the effect of improving phase regulation accuracy and efficiency.

In an example, the terminal device detects a communication quality of the second signal, and when a variation of the communication quality is greater than a quality threshold, the terminal device determines the phase update instruction. Thus, the terminal device can control the repeater to perform phase updates based on real-time changes in the second signal quality, achieving the effect of adapting to environmental changes and improving signal stability.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows an architecture diagram of a wireless communication system according to a preferred embodiment of the present invention.

FIG. 2 shows a configuration diagram of components in a repeater according to a preferred embodiment of the present invention.

FIG. 3 is a diagram showing a control scenario of a repeater according to an embodiment of the present invention.

FIG. 4 is a diagram showing a control scenario of a repeater according to another embodiment of the present invention.

FIG. 5 is a diagram showing a control scenario of a repeater according to another embodiment of the present invention.

FIG. 6 is a diagram showing a control scenario of a repeater according to another embodiment of the present invention.

FIG. 7 shows a comparison diagram of empirical cumulative distribution functions of transmission rates with and without using the repeater of the present invention.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

In order to make the above and other objectives, features, and advantages of the present invention clearer and easier to understand, the preferred embodiments of the present invention will be described hereinafter in connection with the accompanying drawings. Furthermore, the elements designated by the same reference numeral in various figures will be deemed as identical, and the description thereof will be omitted.

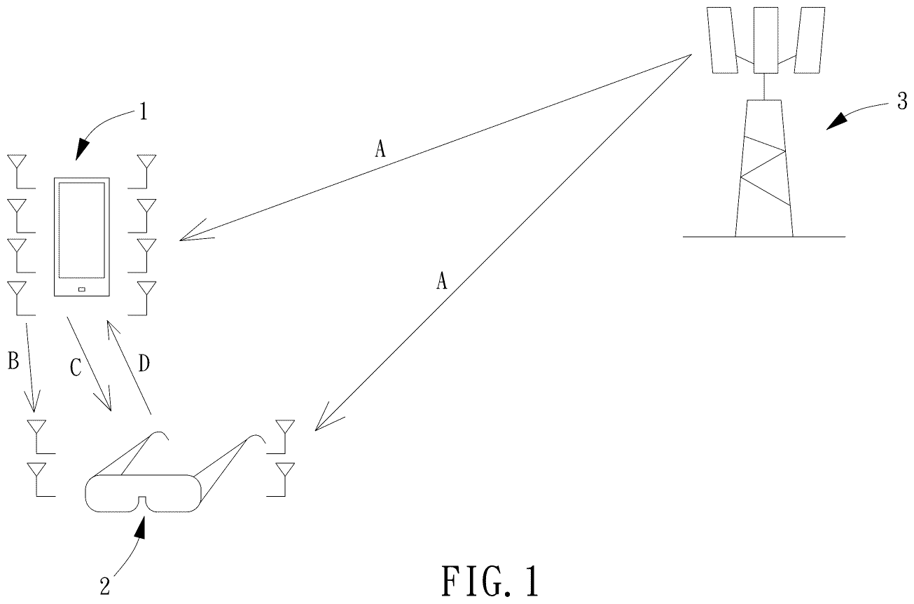

Please refer to FIG. 1, which shows the architecture diagram of a wireless communication system according to a preferred embodiment of the present invention, including a repeater 1, a terminal device 2, and a base station 3. Generally, the terminal device 2 is configured with multiple antennas corresponding to different communication frequency bands, but the antennas are not always in use, resulting in limited system spectrum efficiency. According to some embodiments of the present invention, the repeater 1 performs signal frequency conversion as instructed by the terminal device 2, converting signals from the base station 3 to communication frequency bands of idle antennas in the terminal device 2, to increase the number of antenna usage and spectrum efficiency, thereby improving the communication performance of the terminal device 2. For example, the base station 3 sends a first signal A with a first frequency band to the terminal device 2. The nearby repeater 1 simultaneously receives the first signal A and converts the frequency of the first signal A to a target frequency band corresponding to idle antennas in the terminal device 2, to generate a second signal B within the target frequency band, and sends the second signal B to the terminal device 2.

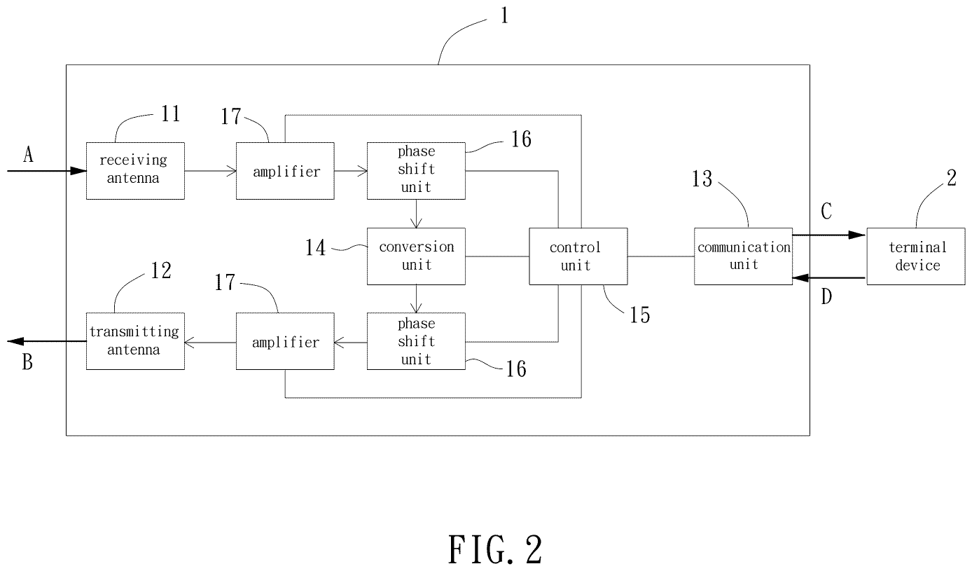

Please refer to FIGS. 1 and 2, where FIG. 2 shows the component configuration of the repeater according to a preferred embodiment of the present invention. In one embodiment, the repeater 1 controlled by the terminal device 2 includes a receiving antenna 11, a transmitting antenna 12, a communication unit 13, a conversion unit 14, and a control unit 15. The communication unit 13 is coupled to the terminal device 2 to receive the usage status of the terminal device 2. The conversion unit 14 is electrically connected to the receiving antenna 11 and the transmitting antenna 12, respectively. The control unit 15 is coupled to the conversion unit 14 and the communication unit 13, respectively. The control unit 15 can adjust the signals received and transmitted by the receiving antenna 11 and the transmitting antenna 12 through the conversion unit 14 according to the usage status of the terminal device 2.

The receiving antenna 11 receives the first signal A from the base station 3, and the transmitting antenna 12 forwards the second signal B, where the first signal A and the second signal B are in different communication frequency bands. In the initial phase, the repeater 1 uses the communication unit 13 to establish a connection with the terminal device 2 through a short-range communication protocol, with the short-range communication protocol including, but not limited to, Bluetooth, Zigbee, and Ultra-wideband protocol. When the repeater 1 first connects with the terminal device 2, it transmits feedback data C through the short-range communication protocol. The feedback data C includes a convertible frequency range and supportable signal specifications of the repeater 1. For example, the feedback data C includes a convertible frequency range of 2.4 GHz to 6 GHz, and supported signal specifications of Wi-Fi 6 and 5G NR standards.

Subsequently, the terminal device 2 selects the desired frequency and specifications based on the feedback data C provided by the repeater 1, and generates a control instruction D, which includes conversion requirements corresponding to the target frequency band and communication specifications. For example, the control instruction D requires a target frequency band of 5 GHz and communication specification of 5G NR standard. Thereby, the control unit 15 of the repeater 1 can instruct the conversion unit 14 to increase or decrease the frequency of the first signal A according to the control instruction D, to generate the second signal B in the target frequency band. For example, the conversion unit 14 converts the first signal A from the base station 3 at 3.5 GHz frequency band to the second signal B at 5 GHz that the terminal device 2 can support.

Based on the above architecture, the repeater 1 of the present invention is controlled by the terminal device 2. Through the terminal device 2 instructing the repeater 1 to perform signal frequency conversion, the first signal A can be converted to communication frequency bands of idle antennas in the terminal device 2, namely the second signal B, thereby increasing the number of antenna usage and spectrum efficiency of the terminal device 2. Furthermore, the above repeater 1 only needs to establish communication with the terminal device 2, with the terminal device 2 leading the communication mechanism and signal regulation, rather than the base station 3 leading communication and signal regulation. Therefore, the repeater 1 does not need to be configured with baseband modules, achieving the effect of simplifying the component configuration and reducing size of the repeater, making it easier to be integrated into portable electronic products.

In some embodiments, the repeater 1 is applied to multi-band operations. The repeater 1 is configured with multiple sets of receiving antennas and transmitting antennas, corresponding to signal processing requirements of different frequency bands. When the base station 3 simultaneously transmits two first signals A of different frequency bands, such as 3.5 GHz and 7 GHZ, the terminal device 2 selectively activates partial antenna sets of the repeater 1. For example, the first receiving antenna set receives the first signal A at 3.5 GHZ, which is converted to 5 GHz frequency band supported by the terminal device 2 after processing by the conversion unit 14, and generates the second signal B. Meanwhile, the second receiving antenna set receives the first signal A at 7 GHz, which is repackaged and converted to communication specifications, such as a Wi-Fi signal format, to generate the second signal B, and then transmitted to the terminal device 2. In brief, the conversion unit 14 repackages the first signal A according to the control instruction D to comply with communication specifications supported by the terminal device 2 and generates the second signal B, that is, the first signal A and the second signal B processed by the repeater 1 can include signals of two or more different frequency bands.

Due to significant path loss in high-frequency signals, such as millimeter waves, during transmission, and the limited deployment of base station 3 or related infrastructure, the widespread use of high-frequency signals in practical applications has been restricted. Although many terminal electronic products already possess communication capabilities corresponding to the high frequency bands, they remain underutilized. According to the aforementioned architecture of the repeater 1, signals can be converted to high frequency bands, and through the short-distance and unobstructed transmission environment between the repeater 1 and the terminal device 2, common transmission limitations of high-frequency signals can be overcome. Therefore, a practical and efficient solution for high-frequency signal applications is provided.

Please refer to FIG. 2, the repeater 1 further includes a phase shift unit 16 and an amplifier 17, which are located between the receiving antenna 11 and the conversion unit 14, or between the transmitting antenna 12 and the conversion unit 14, used for electrically connecting the conversion unit 14, the receiving antenna 11 and the transmitting antenna 12. The control unit 15, in addition to being coupled to the conversion unit 14, is also be coupled to the phase shift unit 16 and the amplifier 17, respectively, to perform phase regulation and amplification conversion of antenna signals. However, the quantity and arrangement of the phase shift unit 16 and the amplifier 17 are not limited to this embodiment.

The control unit 15 can transmit a phase update instruction to operate the phase shift unit 16 for phase regulation, enabling the phase shift unit 16 to regulate the phase of at least one of the first signal A and the second signal B according to the phase update instruction. When phase updates are needed, the repeater 1 only needs to adjust some of the phase shift units 16, rather than readjusting all phase shift units 16, thereby achieving more real-time and effective phase control, which can improve signal quality and stability.

When the terminal device 2 has no idle antennas available, the repeater 1 can also switch the amplifier 17 through the control unit 15 for direct amplification and forwarding of signals, without requiring frequency conversion. Even in this case, although the terminal device 2 cannot use more antennas to receive signals, stable signal source can still be provided by the repeater 1 to improve communication performance.

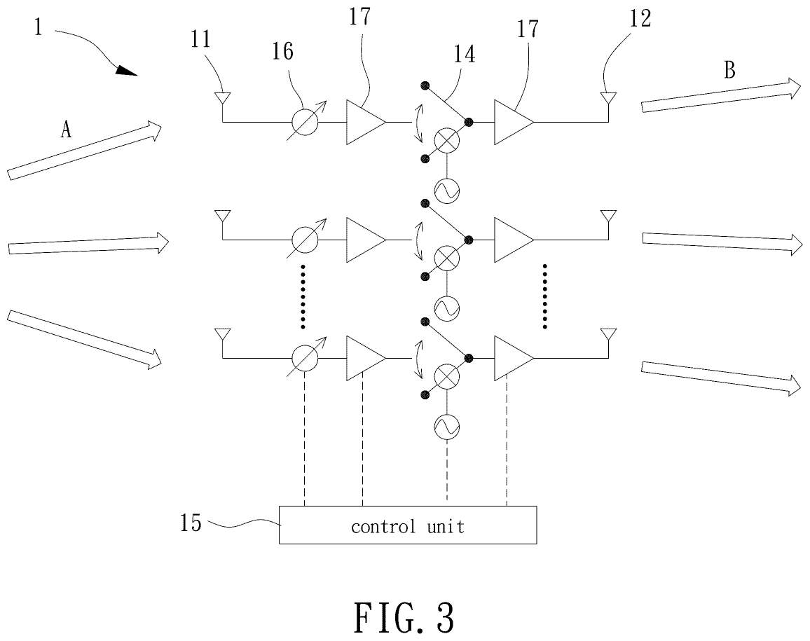

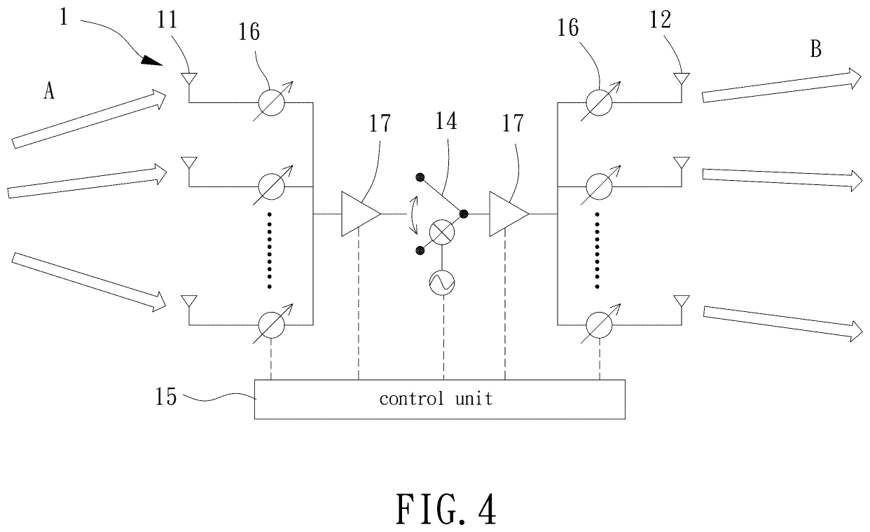

Please refer to FIGS. 3 to 6, which show the architectures of the repeater 1 in four different embodiments. The conversion unit 14 can be composed of switches, local oscillators, and mixers, used for increasing or decreasing the frequency of passing signals. FIGS. 3 and 4 show amplify-and-forward architectures, where after the repeater 1 receives the first signal A, it decides whether frequency conversion is needed according to settings, amplifies the signal, and outputs the second signal B. The signal delay in such an architecture can be considered as zero.

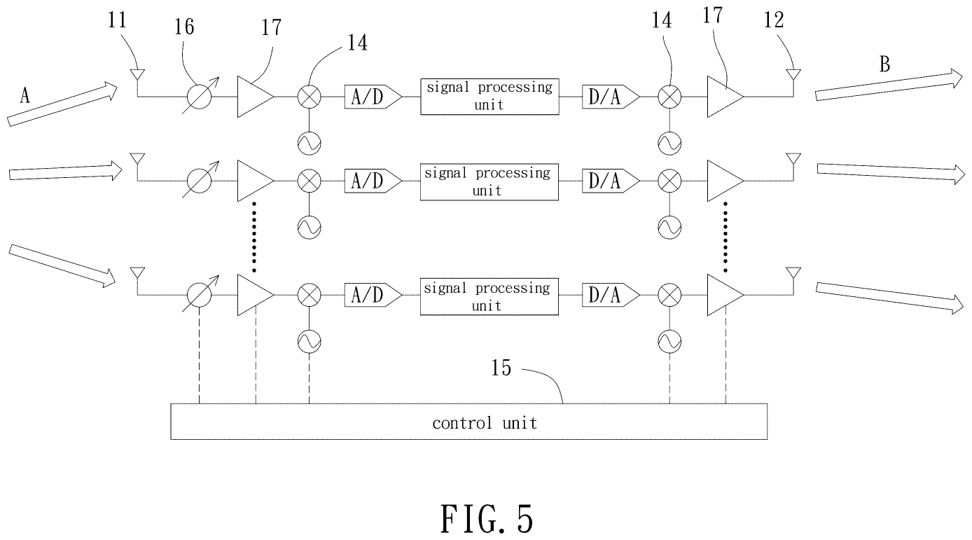

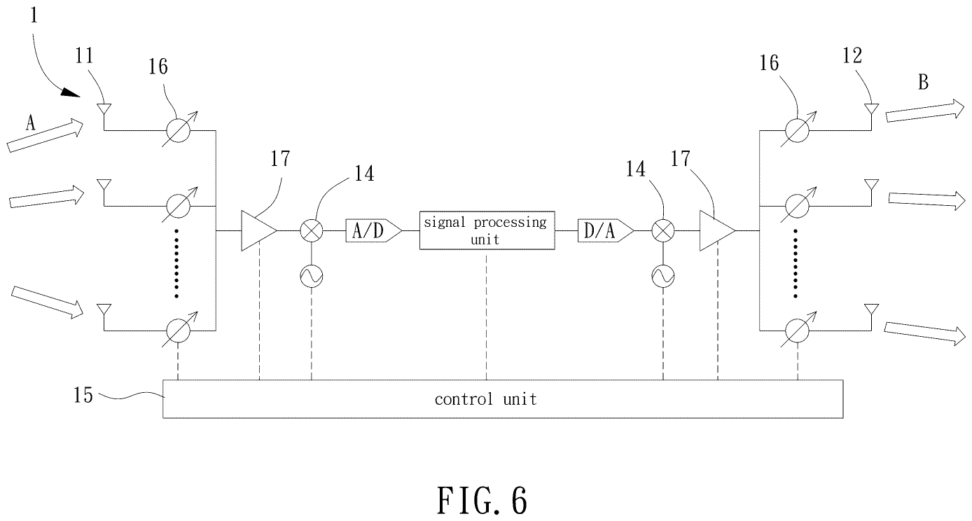

FIGS. 5 and 6 show decode-and-forward architectures, where the repeater 1 additionally includes an analog-to-digital converter (A/D), a digital-to-analog converter (D/A), and a signal processing unit. The repeater 1 repackages received signals before transmission, avoiding noise interference after amplification, resulting in better signal quality but with larger delay.

Please refer to FIG. 1, regardless of which architecture from the above embodiments is adopted, during communication, the repeater 1 only communicates with the terminal device 2, and the base station 3 does not need to sense the existence of the repeater 1. The terminal device 2 can report channel information to the base station 3 based on the combined channel with the repeater 1, avoiding increased burden on the base station 3 from communicating with excessive devices.

In one embodiment, the repeater 1 can also transmit a regulation indicator to the terminal device 2 through the communication unit 13, enabling the terminal device 2 to determine and transmit the phase update instruction to the communication unit 13 based on the regulation indicator. For example, when the terminal device 2 moves, the regulation indicator can be simultaneously monitored for updating usage status. Specifically, the terminal device 2 receives an acknowledgment (ACK) signal from the repeater 1 and records the corresponding reference signal received power (RSRP) value as the regulation indicator. However, the present invention is not limited in this regard. In some embodiments, regulation indicators include indicators such as a signal-to-noise ratio (SNR), a channel capacity, a bit error rate (BER), a link quality, and a received power (RX).

The terminal device 2 can detect and record updated RSRP values in real-time. When the terminal device 2 determines that the variation of the regulation indicator exceeds a preset threshold, the terminal device 2 can determine to transmit the phase update instruction to the communication unit 13. Based on the previous example, when the variation of the regulation indicator, namely the change in RSRP value, exceeds the preset threshold, such as the RSRP decreased by more than 3 dB, the terminal device 2 transmits the phase update instruction to the repeater 1 to control the repeater 1 to update the phase. On the contrary, when the variation of the regulation indicator is below the preset threshold, the terminal device 2 controls the repeater 1 to maintain the original phase.

Please refer again to FIG. 2, after the repeater 1 receives the phase update instruction, the repeater 1 first adjusts the phase shift unit 16 at the receiving end to correct the phase to the optimal state compensating for multipath fading. Then, the repeater 1 adjusts the phase shift unit 16 at the transmitting end to ensure high-quality second signal B is sent to the terminal device 2. If the signal quality after updating still fails to meet the standard, the above phase regulation steps are iterated again until the variation of the regulation indicator is below the preset threshold, such as the RSRP being above −75 dBm. Thus, the repeater 1 can dynamically adjust the signal phase through the phase shift unit 16, improving signal quality and stability, achieving the effect of enhancing communication stability and efficiency.

In some embodiments, when the terminal device 2 moves and causes the signal quality of wireless communication to decline, the phase of the repeater 1 will be further adjusted. For example, the terminal device 2 detects a communication quality associated with the second signal B, and when the terminal device 2 determines that the communication quality is below a quality threshold, the terminal device 2 transmits the phase update instruction to the communication unit 13 to control the phase regulation of the phase shift unit 16. Thus, the terminal device 2 can control the phase updates of the repeater 1 based on real-time changes in the quality of the second signal B, achieving the effect of adapting to environmental changes and improving signal stability.

Based on the above architectures and working principles, two application scenarios are provided as examples for further explanation. Scenario one is an application in vehicular communication, where the repeater 1 is configured in a vehicle system and establishes connection with the terminal device 2 used by the driver, such as a smart watch. As the vehicle moves, the relative position of the base station 3 changes, thus requiring phase updates at the receiving end of the repeater 1. On the other hand, the positions of the terminal device 2 and the repeater 1 remain unchanged, thus no phase update is needed at the transmitting end. Scenario two is a signal enhancement in large indoor spaces, where in an indoor environment, the repeater 1 is configured on fixed installations indoors and establishes connection with the terminal device 2 worn by users, such as smart glasses worn by a user moving in indoor spaces. Since the repeater 1 is at a fixed location, the phase at the receiving end of the repeater 1 receiving signals from the base station 3 is fixed, but as the terminal device 2 moves indoors, phase updates are needed at the transmitting end of the repeater 1.

From the above two application scenarios, it can be seen that when updating phases, it is not necessary to simultaneously regulate phases at both the receiving and the transmitting ends of the repeater 1; only one end needs to be regulated according to specific situations. That is, the terminal device 2 determines whether the relative position between the terminal device 2 and the repeater 1 has changed by detecting the strength and/or quality of the regulation indicator, thereby deciding whether to update the phase at the transmitting or the receiving end, simplifying the phase regulation mechanism and enabling real-time and effective phase adjustment to reduce phase regulation time.

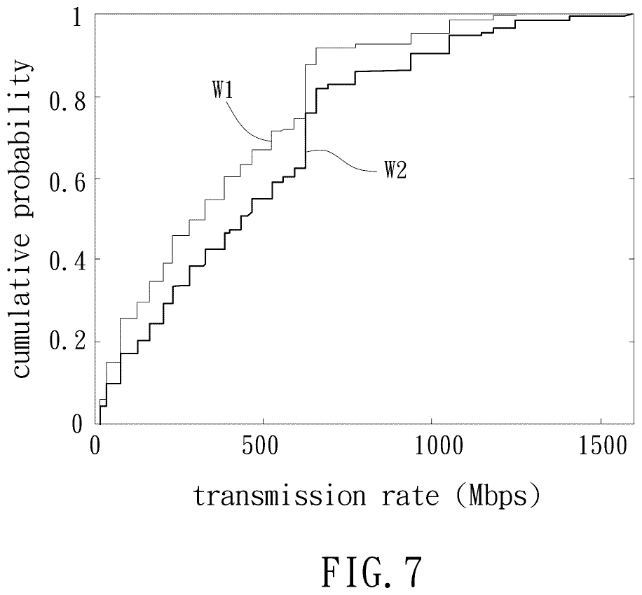

Please refer to FIG. 7, which shows a comparison of empirical cumulative distribution function (ECDF) of transmission rates between communication systems with and without using the repeater of the present invention in an urban district environment, represented by transmission rate cumulative distribution function curve W1 without repeater and curve W2 with repeater. The statistical results are shown in Table 1 below. From the simulation experimental data, it can be seen that with assistance of the repeater, transmission rates show significant improvement. Taking 95% of the cumulative distribution function as an example, using the repeater can relatively increase transmission rate by approximately 115 Mbps.

TABLE 1

| | CDF 68% | CDF 95% |
|---|---|---|
| Without repeater | 524.704 Mbps | 934.432 Mbps |
| With repeater | 623.104 Mbps | 1049.5 Mbps |

Subsequently, as shown in Table 2 below, actual measurements in indoor environments showed that using the repeater can increase the communication system's transmission rate by approximately 129 Mbps.

TABLE 2

| | Transmission rate |
|---|---|
| Without repeater | 503.4 Mbps |
| With repeater | 632.4 Mbps |

From the above test results, it can be seen that the performance enhancement effect of the repeater according to the present invention on communication systems can effectively improve communication performance in different application scenarios, significantly enhancing the data transmission rate of communication systems.

Please refer to FIGS. 1 and 2, the control method for the repeater 1 of the present invention, executed by a terminal device 2, is applicable to control the repeater 1 of various architectures as described above. The method includes the following steps: first, the terminal device 2 establishes a connection with the repeater 1 through a short-range communication protocol; the terminal device 2 receives feedback data C from the repeater 1, which includes a convertible frequency range and supportable signal specifications of the repeater 1; the terminal device 2 determines a control instruction D corresponding to a target frequency band and a communication specification, and transmits the control instruction D to the repeater 1. The mechanism of exchanging the feedback data C and the control instruction D through short-range communication protocol between the terminal device 2 and the repeater 1 and the derivative embodiments have been described above, and can be implemented through the aforementioned repeater 1 controlled by the terminal device 2.

Secondly, the repeater 1 adjusts the frequency of the first signal A from the base station 3 according to the control instruction D to generate the second signal B within the target frequency band. The mechanism of frequency conversion and the derivative embodiments have been described above, and can be implemented through the aforementioned repeater 1 controlled by the terminal device 2.

Finally, the repeater 1 transmits the second signal B to the terminal device 2. Thus, the repeater 1 can convert the first signal A to the second signal B to match the frequency band used by idle antennas of the terminal device 2, enabling the terminal device 2 to utilize the idle antennas to receive signals, effectively increasing the number of available antennas and spectrum efficiency of the terminal device 2.

Based on the above steps, the method for controlling the repeater of the present invention, through the feedback data C and the control instruction D exchanged by communication between the terminal device 2 and the repeater 1, controls the repeater 1 to perform signal frequency conversion. Thus, signals can be converted to communication frequency bands of idle antennas in the terminal device 2, thereby increasing the number of antenna usage and spectrum efficiency of the terminal device 2, and achieving the effect of simplifying the design and reducing the size of the repeater 1.

In some embodiments, the method further includes the repeater 1 repackaging the first signal A according to the control instruction D to comply with the communication specification. The operating principles, related technical content, and the effects have been described above and are thus omitted here. Therefore, converting signals to formats compliant with different communication protocols can enhance system compatibility and flexibility, achieving the effect of supporting multi-protocol operations.

In some embodiments, the method further includes the repeater 1 regulating the phase of at least one of the first signal A and the second signal B according to a phase update instruction. The operating principles, related technical content, and the effects have been described above and are thus omitted here. Therefore, signal phase can be dynamically adjusted, achieving the effect of improving communication stability and efficiency.

In some embodiments, the method further includes the terminal device 2 detecting a regulation indicator from the repeater 1, and when a variation of the regulation indicator is greater than a preset threshold, deciding the phase update instruction. The operating principles, related technical content, and the effects have been described above and are thus omitted here. Therefore, through adaptively selecting real-time detection of the regulation indicator, the real-time status of communication links can be accurately reflected, achieving the effect of improving phase regulation accuracy and efficiency.

In some embodiments, the method further includes the terminal device 2 detecting a communication quality of the second signal B, and when a variation of the communication quality is greater than a quality threshold, deciding the phase update instruction. The operating principles, related technical content, and the effects have been described above and are thus omitted here. Therefore, the terminal device 2 can control phase updates of the repeater 1 based on real-time changes in the quality of the second signal B, achieving the effect of adapting to environmental changes and improving signal stability.

In summary, the repeater controlled by terminal device and the control method of the present invention, through the terminal device instructing the repeater to perform signal frequency conversion, achieves converting signals to communication frequency bands supported by idle antennas, thereby increasing antenna usage efficiency of the terminal device and enhancing spectrum efficiency. Meanwhile, the repeater controlled by terminal device and the control method of the present invention also eliminate the need for the repeater to be configured with baseband modules, thereby simplifying the design and reducing the size of the repeater, making it easier to be integrated into portable electronic products. Furthermore, through an efficient phase regulation mechanism, signal quality and stability can be improved. Moreover, the terminal device can adjust phase in real-time and effectively based on real-time changes in regulation indicators and signal quality, reducing phase regulation time, achieving the effect of adapting to environmental changes and improving signal stability.

Although the present invention has been described with respect to the above preferred embodiments, these embodiments are not intended to restrict the present invention. Various changes and modifications on the above embodiments made by any person skilled in the art without departing from the spirit and scope of the present invention are still within the technical category protected by the present invention. Accordingly, the scope of the present invention shall include the literal meaning set forth in the appended claims and all changes which come within the range of equivalency of the claims. Furthermore, in a case that several of the above embodiments can be combined, the present invention includes the implementation of any combination.

What is claimed is:

1. A repeater controlled by a terminal device, comprising:
a communication unit coupled to the terminal device through a short-range communication protocol, wherein the communication unit transmits feedback data to the terminal device, which includes a convertible frequency range and supportable signal specifications, and wherein the communication unit receives a control instruction from the terminal device, which includes a target frequency band and a communication specification;
a control unit coupled to the communication unit, configured to receive the control instruction; and
a conversion unit electrically connected to a receiving antenna and a transmitting antenna, respectively, wherein the receiving antenna receives a first signal from a base station, wherein the conversion unit is coupled to the control unit, the control unit operates the conversion unit to adjust a frequency of the first signal according to the control instruction to generate a second signal in the target frequency band, and wherein the transmitting antenna transmits the second signal to the terminal device.

2. The repeater as claimed in claim 1, wherein the communication unit transmits a regulation indicator to the terminal device, receives a phase update instruction from the terminal device, and transmits the phase update instruction to the control unit.

3. The repeater as claimed in claim 2, further comprising a phase shift unit electrically connected to the conversion unit, the receiving antenna and the transmitting antenna, wherein the phase shift unit is coupled to the control unit, and the control unit controls the phase shift unit according to the phase update instruction to regulate a phase of at least one of the first signal and the second signal.

4. The repeater as claimed in claim 2, wherein when the terminal device determines that a variation of the regulation indicator is greater than a preset threshold, the terminal device determines the phase update instruction to transmit to the communication unit.

5. The repeater as claimed in claim 2, wherein when the terminal device detects that a communication quality of the second signal is lower than a quality threshold, the terminal device determines the phase update instruction to transmit to the communication unit.

6. A method for controlling a repeater, executed by a terminal device, comprising:
the terminal device establishing a connection with the repeater through a short-range communication protocol;
the terminal device receiving feedback data from the repeater, which includes a convertible frequency range and supportable signal specifications of the repeater;
the terminal device deciding a control instruction corresponding to a target frequency band and a communication specification, and transmitting the control instruction to the repeater;
the repeater adjusting a frequency of a first signal from a base station according to the feedback data and the control instruction to generate a second signal in the target frequency band; and
the repeater transmitting the second signal to the terminal device.

7. The method for controlling the repeater as claimed in claim 6, wherein the repeater repackages the first signal according to the control instruction to comply with the communication specification.

8. The method for controlling the repeater as claimed in claim 6, wherein the repeater regulates a phase of at least one of the first signal and the second signal according to a phase update instruction.

9. The method for controlling the repeater as claimed in claim 8, wherein the terminal device detects a regulation indicator of the repeater, and when a variation of the regulation indicator is greater than a preset threshold, the terminal device determines the phase update instruction.

10. The method for controlling the repeater as claimed in claim 8, wherein the terminal device detects a communication quality of the second signal, and when a variation of the communication quality is greater than a quality threshold, the terminal device determines the phase update instruction.
